(19) United States
(12) Patent Application Publication
(10) Pub. No.: US 2007/0296961 A1
(43) Pub. Date: Dec. 27, 2007

(54) Vehicle Lamp Inspection Equipment and Inspection Method

(76) Inventors: Keita Sekine, Saitama-ken (JP); Kazuyuki Fukamachi, Tochigi-ken (JP); Kazuaki Funahara, Mie-ken (JP); Ryohei Kawaguchi, Mie-ken (JP)

Correspondence Address: ARENT FOX LLP, 1050 CONNECTICUT AVENUE, N.W., SUITE 400, WASHINGTON, DC, 20036, US

(21) Appl. No.: 11/791,325

(22) PCT Filed: Nov. 25, 2005
(86) PCT No.: PCT/JP05/21732

§ 371 Date: May 23, 2007

(30) Foreign Application Priority Data
Nov. 26, 2004 (JP) 2004-342807
Nov. 26, 2004 (JP) 2004-342818
Nov. 26, 2004 (JP) 2004-342857
Nov. 26, 2004 (JP) 2004-342842

(51) Int. Cl. G01J 1/00

(52) U.S. Cl. 356/213

(57) ABSTRACT

A vehicle lamp inspection equipment comprises a vehicle position recognizing section for detecting arrival of a vehicle at an inspection position, a terminal to be connected with an ECU mounted on the vehicle, cameras for imaging the lamp of the vehicle which has arrived at the inspection position from the right and left front, cameras for imaging from the right and left rear, spot lights for illuminating the right and left wheels and long fluorescent lights for illuminating the right and left rear wheels. When the vehicle has arrived at the inspection position, a main processing section turns on or flashes the lamp through the terminal and the ECU and acquires image data from the cameras, thereby checking the lamp.

### TECHNICAL FIELD

The present invention relates to an apparatus (equipment) for and a method of inspecting various vehicle lamps for their turned-on state and blinking state on an inspection line after vehicles have been assembled.

### BACKGROUND ART

Processes for manufacturing and assembling vehicles include various inspecting processes performed on vehicles after they have been assembled. The inspecting processes include a confirmative inspection for inspecting whether or not a lamp on a vehicle is properly turned on or blinked to confirm a failure such as a wire disconnection or a bulb burnout.

The lamp inspection is carried out as follows: The inspector actually gets into the vehicle and sits on the driver seat, and directly operates a switch to turn or blink the lamp. The inspector confirms the turning-on or blinking of the lamp by looking at images captured by cameras and displayed on a monitor or mirrors around the vehicle.

As a technology for automating the inspection based on the visual confirmation, there has been proposed a method of inspecting a headlamp by placing a screen in front of the headlamp and capturing an irradiated pattern on the screen with a camera for inspection (see, for example, Japanese Laid-Open Patent Publication No. 8-15093). The relationship between the aperture and the illumination intensity is stored in advance, and the illumination intensity of the headlamp is determined from the aperture of the camera which has detected the irradiated pattern and the image data. The method is preferable as it can simultaneously measure the optical axis and illumination intensity of the headlamp.

There has been disclosed an apparatus for inspecting a turn indicator by capturing an image of a blinking turn indicator with an image capturing means, recording the captured image in an image storing means, and performing a processing operation with processing means based on the image information to automatically inspect whether the blinked state of the turn indictor is good or not (see, for example, Japanese Laid-Open Patent Publication No. 6-129945).

A lamp unit on a vehicle comprises an integral combination of a high-beam lamp, a low-beam lamp, and a small lamp which are disposed very closely to each other. A lens in front of the lamps somewhat diffuses the emitted light, and a reflecting plate disposed behind the light sources commonly reflects the light emitted by the lamps. Therefore, when these lamps are inspected for their energization, it is difficult to determine which one of the lamps is turned on. An inspecting method for reliably inspecting individual lamps is desirable.

As a technology for inspecting a headlamp, there has been proposed a method of inspecting a headlamp by placing a screen in front of the headlamp and capturing an irradiated pattern on the screen with a camera for inspection (see, for example, Japanese Laid-Open Patent Publication No. 8-15093). The relationship between the aperture and the illumination intensity is stored in advance, and the illumination intensity of the headlamp is determined from the aperture of the camera which is detected and the image data. The method is preferable as it can simultaneously measure the optical axis and illumination intensity of the camera.

In order to correct the position of the vehicle on an inspection line for inspecting a headlamp on the vehicle, there has been proposed a method of detecting upper and lateral sides of a headlamp on the vehicle, detecting a skew of the vehicle in a horizontal direction from the positions of the upper and lateral sides, and correcting coordinates depending on the skew angle at the time of inspecting the headlamp (see, for example, Japanese Patent Publication No. 6-63911).

Various lamps for use on vehicles include a high-beam headlamp, a low-beam headlamp, a small lamp, a turn indicator, a fog lamp, a brake lamp, etc. According to the above conventional art, in order to successively inspect a plurality of lamps of different types, the worker has to operate the switches of the lamps in a prescribed sequence based on its memory or a manual. Such a process has a risk of malfunction or an inspection failure.

Also, since the switches are operated manually, a long period of inspection time tends to be required depending on different skill levels of workers.

Image data produced when an image of a vehicle is captured may include a plurality of lamps. If the entire screen of such image data is processed, then a long period of image processing time is required. Consequently, if a plurality of inspection spots are present in the image data, then an inspection window should be established for each of the inspection spots to limit a range for inspection therefor, for thereby reducing the amount of processing operation and increasing the inspection accuracy.

For establishing an inspection window of suitable size for each of a plurality of lamps, then the vehicle has to be accurately positioned, and hence a positioning mechanism for precisely positioning the vehicle is required. Such a positioning mechanism needs large actuators, highly accurate sensors, and complex mechanisms, causes concerns over a high cost for its implementation, and needs an extra time for positioning the vehicle at the time it is inspected, resulting in a tendency to lower the inspection efficiency. If there are a plurality of types of vehicles to be inspected, then a complex process is required to change the operation of the positioning mechanism for each of the vehicle types.

When an image of a lamp unit is captured, it is difficult to determine which one of the lamps is turned on, and an inspecting method for reliably inspecting individual lamps is desirable. According to Japanese Laid-Open Patent Publication No. 8-15093, the cost is high and the scale of equipment is large because mechanisms such as a screen and a camera aperture detecting means are used to inspect the headlamp.

According to Japanese Laid-Open Patent Publication No. 8-15093, inasmuch as the headlight illumination intensity is determined from the image data and the aperture data, the camera has an aperture mechanism, and complex mechanism and procedure are required for performing aperture control so that the amount of detected light from the headlight will not exceed the measurement range of the camera. Furthermore, the disclosed method makes it difficult to inspect a small lamp for energization since a light beam with a small amount of light is not projected onto the screen.

If the camera is disposed in facing relation to the headlamp as disclosed in Japanese Laid-Open Patent Publication No. 8-15093, then the camera can be used to both detect the position of the vehicle and inspect the headlamp.

Image data produced when an image of a vehicle is captured may include a plurality of lamps. If the entire screen of such image data is processed, then the image processing requires a long time. Consequently, if a plurality of inspection spots are present in the image data, then an inspection window should be established for each of the inspection spots to limit a range for image processing, for thereby reducing the amount of processing operation and increasing the inspection accuracy.

According to the method of determining a skew of the vehicle in a horizontal direction from the positions of the upper and lateral sides of the headlamp, as disclosed in Japanese Laid-Open Patent Publication No. 6-129945, if a plurality of lamps other than the headlamp are to be inspected, then inspection windows established for the respective lamps tend to be vertically displaced, with the result that a lamp to be inspected may run off the edge of an inspection window.

According to the method disclosed in Japanese Laid-Open Patent Publication No. 6-129945, when lamps on a rear portion of a vehicle are inspected, an inspection window may possibly be greatly displaced with respect to a lamp to be inspected.

### DISCLOSURE OF THE INVENTION

It is an object of the present invention to provide an automatic vehicle inspecting apparatus for automating a process of inspecting a vehicle lamp for its turned-on state and blinking state to prevent a human-induced inspection error from occurring and also to make a quick inspection possible.

Another object of the present invention is to provide a vehicle lamp inspecting method which is capable of inspecting a lamp simply and quickly without the need for a complex and expensive vehicle positioning mechanism.

Still another object of the present invention is to provide a vehicle lamp inspecting method which is capable of distinguishing and inspecting lamps of a lamp unit with a simple apparatus and procedure.

Yet another object of the present invention is to provide a vehicle lamp inspecting method which employs an image capturing device to both detect the position of a vehicle and inspect a lamp and which is capable of detecting the position of a vehicle highly accurately to inspect a lamp more reliably.

A vehicle lamp inspecting apparatus according to the present invention has a vehicle position recognizing unit for detecting arrival of a vehicle at a prescribed inspection position, a terminal unit connected to an electronic control unit mounted on the vehicle, for sending an operation signal to the electronic control unit to turn on or blink lamps, image capturing devices for capturing images of the lamps on the vehicle that has reached the inspection position, and an inspection unit connected to the vehicle position recognizing unit and the terminal unit, for acquiring image data from the image capturing devices, wherein when the inspection unit detects the arrival of the vehicle at the inspection position based on a signal from the vehicle position recognizing unit, the inspection unit controls the terminal unit and the electronic control unit to turn on or blink the lamps, acquires the image data from the image capturing devices, and inspects the lamps based on the image data.

The inspection unit, the vehicle position recognizing unit, the terminal unit, and the image capturing devices may be connected by a wired link or a wireless link.

As described above, when the inspection unit detects the arrival of the vehicle at the prescribed inspection position, the inspection unit controls the terminal unit and the electronic control unit to turn on or blink the lamps automatically, and the image capturing devices acquire the image data of the lamps. The inspection of the lamps is thus automated, human-induced inspection errors are prevented from occurring, and the inspection is carried out quickly.

The lamp may include headlamps, turn indicators, and other lamps, and the inspection unit may inspect the headlamps for energization, the turn indicators for blinking, and the other lamps for energization based on different image data of the lamps. The different image data are image data captured at different image capturing times, or if a plurality of cameras are provided, the different image data are image data captured in different image capturing ranges by different cameras. With this arrangement, highly bright light emitted from the headlamps does not adversely affect the image data used to inspect the turn indicators and other low-brightness lamps. Therefore, the lamps can be inspected accurately.

The image capturing devices may be disposed in lateral positions outside the width of the vehicle in front of a front end of the vehicle which has reached the inspection position and in lateral positions outside the width of the vehicle behind a rear end of the vehicle which has reached the inspection position. With this arrangement, the entire periphery of the vehicle that has arrived at the prescribed position can be imaged by four cameras, without dedicated cameras for imaging side portions of the vehicle. Since the cameras are disposed outside the width of the vehicle, the vehicle can pass between the left and right cameras. This arrangement lends itself to a so-called line inspection process.

According to the present invention, there is also provided a method of inspecting lamps of a vehicle with image capturing devices and an inspection unit connected to a terminal unit having a communication function, comprising connecting the terminal unit to an electronic control unit mounted on the vehicle, sending an operation signal from the inspection unit through the terminal unit to the electronic control unit to turn on or blink the lamps of the vehicle when the inspection unit detects the arrival of the vehicle at a prescribed inspection position, acquiring image data by capturing images of the lamps with the image capturing devices, and processing the image data to inspect the lamps.

When the image capturing devices capture the images of the lamps, the image capturing devices may capture the images so that the image data contain the lamps and the side surfaces of the wheels of the vehicle. The method may comprise the steps of establishing, on the image data, elongate wheel position confirmation windows in positions horizontally across the edges of the side surfaces of the wheels, and inspection windows in reference positions, longitudinally scanning the wheel position confirmation windows to detect the edges of the side surfaces of the wheels from a brightness change, determining an offset representing the difference between the edges and a wheel reference position, correcting the inspection windows by moving the inspection windows to positions including the lamps, based on the offset, and inspecting operating states of the lamps by determining brightness in the corrected inspection windows.

As the edges of the wheels are detected by scanning the wheel inspection windows set in positions across the wheels, the positional relationship between the lamps of the vehicle and the image capturing devices can appropriately be detected. Consequently, the inspection windows can be corrected by being moved to the positions including the lamps based on the offset representing the difference between the edges of the wheels and the wheel reference position. The lamps can thus be inspected simply and quickly. The vehicle lamp inspecting method does not employ complex vehicle positioning mechanisms, etc., but can employ simple, inexpensive devices.

When the image capturing devices capture the images of the lamps, the wheels may be illuminated by illuminating units. Since the image data thus obtained are clear and have sharp contrast, the edges of the wheels can be detected accurately.

When the image capturing devices capture the images of the lamps, the image capturing devices may capture the images so that the image data contain the lamps of the vehicle. The method may comprise the steps of acquiring a model of the vehicle, detecting a stopped position of the vehicle from the model and the image data, establishing, on the image data, inspection windows in positions including the lamps based on the model and the detected stopped position, and determining brightness in the inspection windows.

Inasmuch as the stopped position of the vehicle is detected from the image data, simple, inexpensive devices can be employed without vehicle positioning mechanisms, etc. Based on the acquired model and the detected stopped position, inspection windows are established in positions including the lamps. Consequently, the image data makes itself compatible with different models of vehicles, the lamps can be inspected simply and quickly, and the versatility is increased.

The lamps may include a plurality of lamps incorporated in a lamp unit, and when the image capturing devices capture the images of the lamps, the image capturing devices may capture the images so that the image data contain the lamp unit while at least one of the lamps is being energized. The method may comprise the steps of establishing an inspection window including an image of the lamp unit on the image data, binarizing the inspection window on the image data with a predetermined brightness value, determining an area of a portion of the inspection window which represents one of two binarized values, and inspecting operating states of the lamps based on the area.

As described above, the image data with the energized lamps contained therein are binarized using the predetermined brightness value. By determining the area of the portion of the inspection window which represents one of the two binarized values, operating states of the lamps can be inspected based on the area. No screen and no camera aperture mechanism are necessary, and hence simple and small devices can be used.

The area-based inspection may be performed based on the area ratio of the area of a portion which is highly bright due to light emitted from the lamps and whose brightness value is in excess of a predetermined threshold value, to the entire area of the inspection window.

Acceptable ranges for the area may be established depending on the types of the lamps, and operating states of the lamps of the respective types may be inspected based on the acceptable ranges.

The method may include the first step of, when image capturing devices capture the images of the lamps, capturing the images of the lamps so that the image data contain the lamps and the side surfaces of the wheels of the vehicle, the second step of establishing, on the image data, elongate wheel position confirmation windows in positions horizontally across edges of the side surfaces of the wheels, the third step of longitudinally scanning the wheel position confirmation windows to detect the edges of the side surfaces of the wheels from a brightness change, the fourth step of establishing elongate body position confirmation windows in positions vertically across an edge of a body of the vehicle, based on the edges of the side surfaces of the wheels, the fifth step of longitudinally scanning the body position confirmation windows to detect the edge of the body from a brightness change, the sixth step of detecting a vehicle height and a tilt of the body from the edge of the body, and the seventh step of detecting positions of the lamps and inspecting operating states of the lamps based on the vehicle height and the tilt.

By scanning the wheel position confirmation windows, the edges of the side surfaces of the wheels are determined, and a horizontal position of the vehicle is identified. Based on the edges of the side surfaces of the wheels, the body position confirmation windows are established in the positions vertically across the edge of the body of the vehicle, and are scanned to determine the height of the body accurately at the positions. From the determined height and given other parameters, the position of the vehicle is detected with high accuracy for reliably inspecting the lamps.

Since the image capturing devices capture images from oblique positions, the image capturing devices may be used to both detect the position of the vehicle and inspect the lamps. Therefore, the apparatus used may be inexpensive to construct, and is widely applicable to vehicles having different overall lengths.

The seventh step may comprise the sub-step of establishing inspection windows in reference positions, and the sub-step of correcting the inspection windows by moving the inspection windows to positions including the lamps, based on the vehicle height or the tilt. By determining brightness in the corrected inspection windows, the lamps to be inspected are reliably included in the inspection windows, and the operated states of the lamps can be inspected highly reliably.

The wheel position confirmation windows may be established in positions horizontally across the edges of side surfaces of tires of the wheels in the second step, the wheel position confirmation windows may be longitudinally scanned to detect the edges of the side surfaces from a brightness change in the third step, and the body position confirmation windows may be established in positions based on the diameters of the tires which have been recorded in advance, on a vertical line passing through a central position between the detected edges of the side surfaces in the fourth step.

The body position confirmation windows can thus be established in positions including edges of wheel houses through a simple procedure. Since the upper ends of the wheel houses lie substantially horizontally, the edges can easily and reliably be detected by being vertically scanned. The upper ends of the wheels can also be detected by scanning the body position confirmation windows. Since the height of the wheels is known, the height of the upper ends of the wheel houses can accurately be determined based on the height of the wheels.

When the vehicle is obliquely imaged, the gap between the wheels and the wheel houses can easily be measured as it is the widest at the upper ends.

### BRIEF DESCRIPTION OF THE DRAWINGS

FIG. 1 is a schematic plan view of a vehicle lamp inspecting apparatus according to an embodiment of the present invention;

FIG. 2 is a perspective view showing a vehicle position recognizing unit, a vehicle, and cameras disposed on a track;

FIG. 3 is a perspective view of a terminal unit;

FIG. 4 is a schematic connection wiring diagram of the terminal unit, an ECU, and peripheral circuits thereof;

FIG. 5 is a block diagram of a main processor;

FIG. 6 is a side elevational view showing the positions of the cameras with respect to the vehicle;

FIG. 7 is a view showing image data produced when an image of a right front portion of the vehicle is captured;

FIG. 8 is a view showing image data produced when an image of a right rear portion of the vehicle is captured;

FIG. 9 is a flowchart showing an inspection procedure of a process of inspecting a lamp;

FIG. 10 is a flowchart showing a procedure for detecting an edge of a front wheel and an edge of a wheel house;

FIG. 11 is an enlarged partial view of the image data produced when the image of the right front portion of the vehicle is captured for detecting the edges;

FIG. 12 is a flowchart showing a procedure for inspecting turn indicators based on windows;

FIG. 13 is a flowchart showing a procedure for inspecting a high-beam headlamp, a low-beam headlamp, and a front small lamp;

FIG. 14A is a view showing a front lamp confirmation window in which the front small lamp is turned on;

FIG. 14B is a view showing a front lamp confirmation window in which the low-beam headlamp is turned on;

FIG. 14C is a view showing a front lamp confirmation window in which the high-beam headlamp is turned on; and

FIG. 15 is a flowchart showing a procedure for inspecting a front turn indicator for blinking.

### BEST MODE FOR CARRYING OUT THE INVENTION

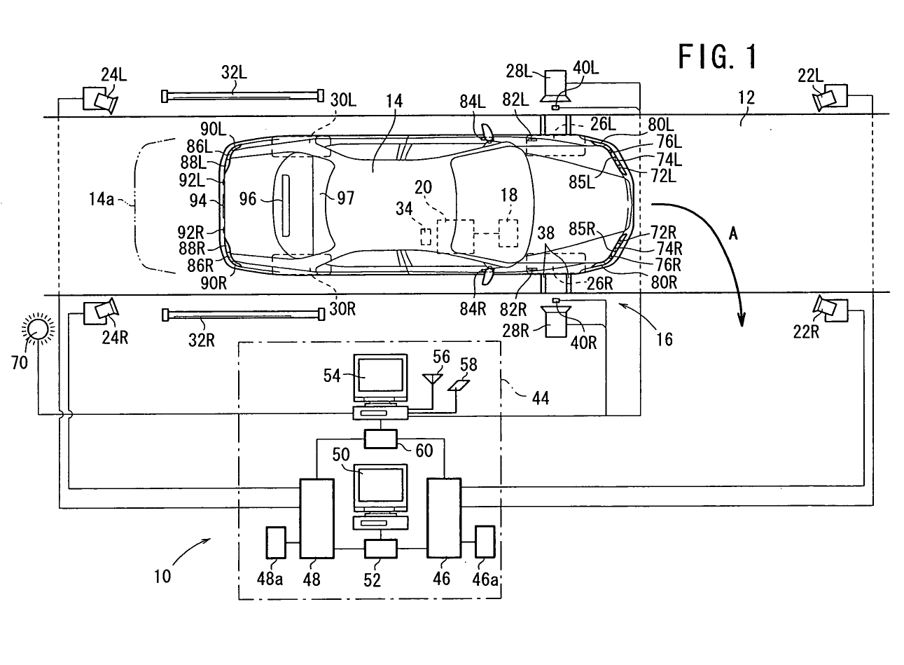

A vehicle lamp inspecting apparatus according to an embodiment of the present invention will be described below with reference to FIGS. 1 through 15 of the accompanying drawings. In a vehicle lamp inspecting apparatus 10 and a vehicle 14, the mechanisms that are provided one on the left side and one on the other will be distinguished from each other by “L” added to the reference numeral assigned to the left mechanism and “R” added to the reference numeral assigned to the right mechanism.

As shown in FIG. 1, the vehicle lamp inspecting apparatus 10 according to the embodiment is an apparatus for inspecting various lamps of a vehicle 14 that is driven by the inspector to enter a track 12. The vehicle lamp inspecting apparatus 10 has a vehicle position recognizing unit 16 for detecting when the vehicle 14 reaches and stops at a prescribed inspection position, a terminal unit 20 connected to an ECU (Electronic Control Unit) 18 mounted on the vehicle 14, cameras (image capturing devices) 22L, 22R for capturing images of lamps on the vehicle 14 that has reached the inspection position from left and right front positions, cameras 24L, 24R for capturing images of lamps on the vehicle 14 from left and right rear positions, spotlights (illuminating units) 28L, 28R for illuminating left and right front wheels (wheels) 26L, 26R, and elongate fluorescent lamps (illuminating units) 32L, 32R for illuminating left and right rear wheels (wheels) 30L, 30R. These cameras 22L, 22R, 24L, 24R may be CCD (Charge Coupled Devices), CMOS (Complementary Metal Oxide Semiconductor) cameras, or the like.

The vehicle 14 has a detachable inspection ID tag 34 bearing a model code (including vehicle type information, destination information, etc.) of the vehicle 14, a production number code, and information for identifying the terminal unit 20, which are written at an initial stage of a series of inspection steps.

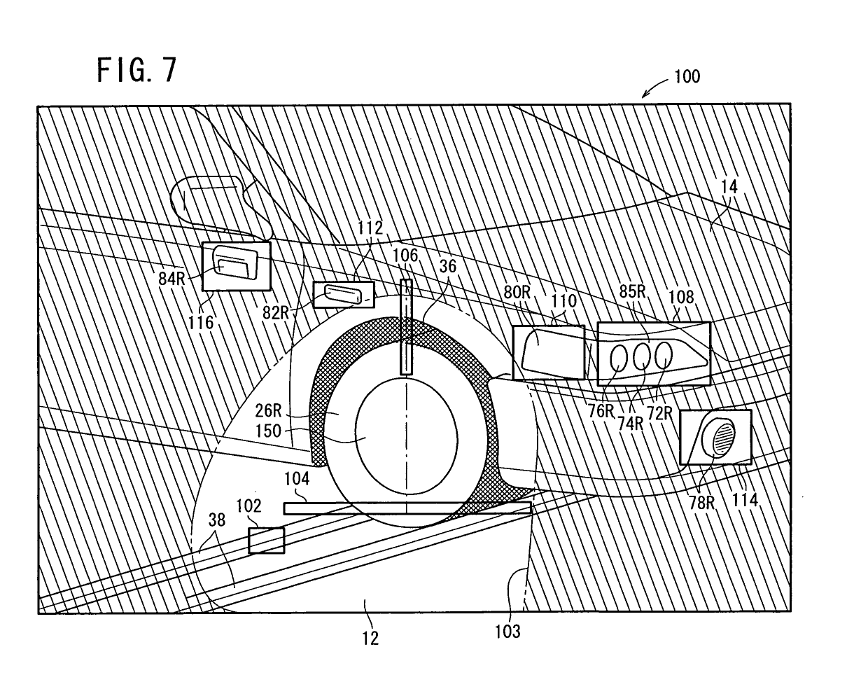

An area around the vehicle lamp inspecting apparatus 10 is not illuminated and hence is dark. Therefore, the front wheels 26L, 26R, the rear wheels 30L, 30R, and edges of a body 36 (see FIG. 7) are illuminated with sharp contrast by the spotlights 28L, 28R and the fluorescent lamps 32L, 32R. Since the area around the vehicle lamp inspecting apparatus 10 is dark, the light emission from the lamps is clearly captured for reliable inspection.

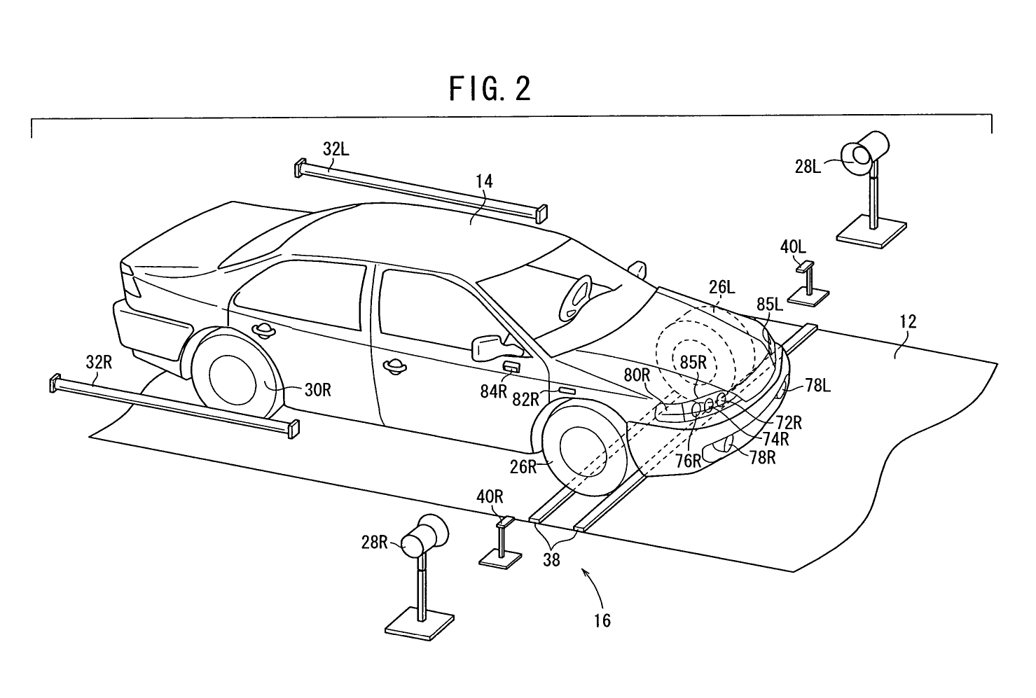

As shown in FIG. 2, the vehicle position recognizing unit 16 has two wheel stops 38 extending across the track 12 and spaced from each other by a distance which is substantially the same as the ground contact width of the front wheels 26L, 26R, and two photoelectric switches 40L, 40R for detecting the front wheels 26L, 26R that ride on the wheel stops 38. A sensor for detecting when the front wheels 26L, 26R ride on the wheel stops 38 may be a load cell or the like, for example.

The vehicle lamp inspecting apparatus 10 is applicable to vehicles 14 of various types. The position of the front wheels 26L, 26R in the longitudinal direction of the vehicle 14 is determined by the wheel stops 38, and the rear wheels 30L, 30R are placed in a position depending on the wheelbase with respect to the wheel stops 38. Since the fluorescent lamps 32L, 32R for illuminating a rear portion of the vehicle 14 are elongate, the fluorescent lamps 32L, 32R can appropriately illuminate the rear wheels 30L, 30R regardless of the magnitude of the wheelbase.

The vehicle lamp inspecting apparatus 10 also has a main processor (inspection unit) 44 connected to the photoelectric switches 40L 40R and the terminal unit 20, for acquiring image data from the cameras 22L, 22R, 24L, 24R. The vehicle lamp inspecting apparatus 10 is connected to the terminal unit 20 by a wireless link.

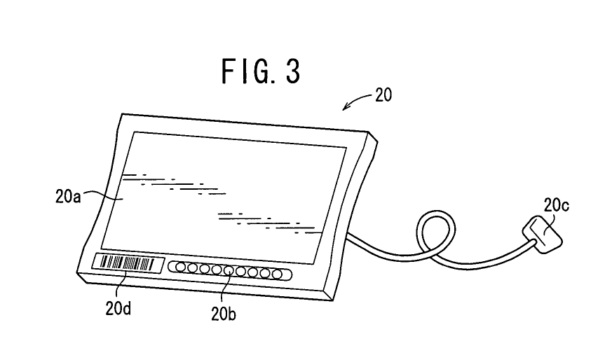

As shown in FIG. 3, the terminal unit 20 is of a flat portable type, and has a monitor 20a, a control pad 20b, a connector 20c connected to the ECU 18, a barcode 20d as an identification code, and a built-in antenna (not shown) for performing wireless communications with the main processor 44. The terminal unit 20 has been loaded with data representing an inspection sequence depending on the vehicle 14, from a predetermined server. The loading process is performed each time the vehicle lamp inspecting apparatus 10 starts to operate, thus making the vehicle lamp inspecting apparatus 10 flexible enough to handle a production plan on the day. The information of the terminal unit 20 which is recorded in the barcode 20d is read with a given reader by the inspector and written into the ID tag 34 referred to above.

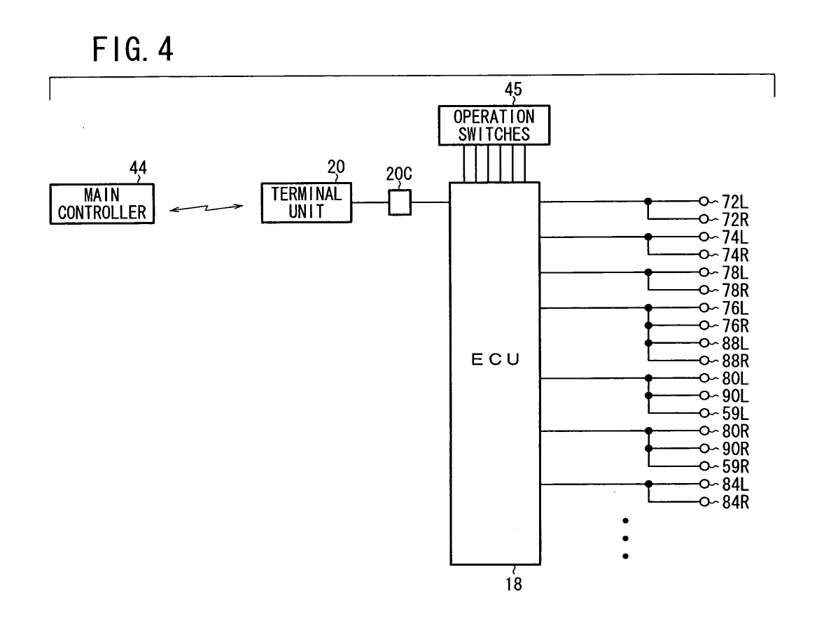

As shown in FIG. 4, when the terminal unit 20 is connected to the ECU 18, and the main processor 44 sends an operation signal to the terminal unit 20, the ECU 18 performs various operations to carry out the so-called emulation process. According to the emulation process, an operation signal is sent to the ECU 18 to turn on or blink lamps, for example.

When the main processor 44 stops sending the operation signal to the terminal unit 20, or when the terminal unit 20 is disconnected from the ECU 18, the emulation process is finished and the ECU 18 returns to a normal mode wherein it controls objects to be operated based on signals supplied from operation switches 45. The operation switches 45 include lamp switches, turn indicator switches, a hazard flasher switch, etc. The connection wiring pattern between the ECU 18 and the lamps is not limited to the pattern shown in FIG. 4, but may be of another connection wiring type or may be in the form of a circuit including relays.

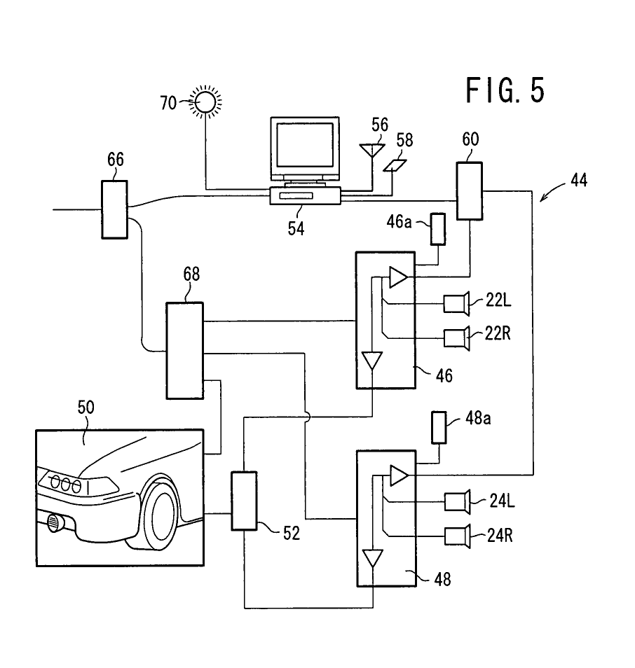

As shown in FIG. 5, the main processor 44 comprises a plurality of devices including a front controller 46 for controlling the cameras 22L, 22R, a rear controller 48 for controlling the cameras 24L, 24R, a confirmation monitor 50 for displaying acquired image data for confirmation, a switcher 52 for switching between images obtained from the cameras 22L, 22R, 24L, 24R for display on the confirmation monitor 50, a main computer 54 for performing a main control process such as for image processing, an antenna 56 connected to the main computer 54 for communications with the terminal unit 20, and an RFID (Radio Frequency Identification) receiver 58 for receiving data from the ID tag 34.

The RFID receiver 58 is able to recognize the model code of the vehicle 14, the production number code, and the identification number of the terminal unit 20 based on wireless information obtained from the ID tag 34. Signals of image data supplied to the confirmation monitor 50 are NTSC (National Television Standards Committee) signals, for example, and are supplied as digital data to the main computer 54.

The main computer 54 is connected to the front controller 46 and the rear controller 48 through a hub 60. Consoles 46a, 48a for performing given adjusting operations are connected respectively to the front controller 46 and the rear controller 48. The main computer 54 is supplied with stable AC power from an uninterruptible power supply 66, and the front controller 46, the rear controller 48, and the confirmation monitor 50 are supplied with stable DC power through a DC converter 68. A pilot lamp 70 for indicating that the vehicle 14 is being inspected is connected to the main computer 54, and is placed near the track 12.

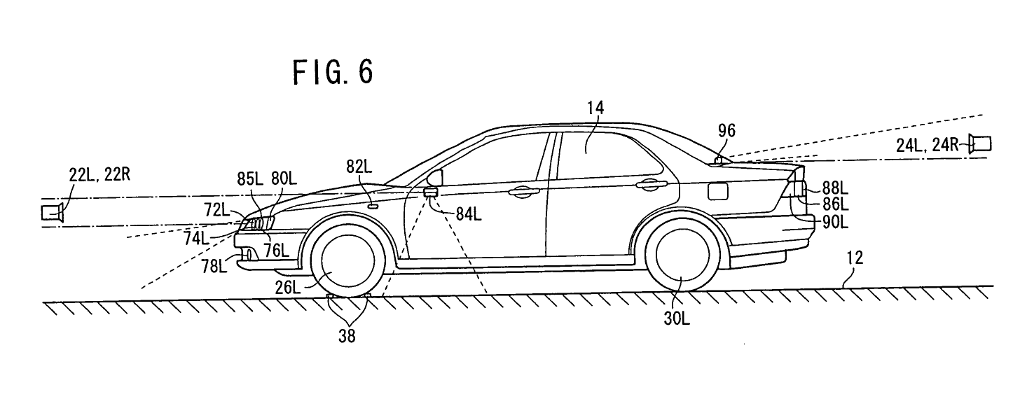

As shown in FIGS. 1 and 6, lamps to be inspected are all lamps for emitting light away from the vehicle body. Those lamps that are mounted on a front portion of the vehicle 14 include high-beam headlamps 72L, 72R, low-beam headlamps 74L, 74R, front small lamps 76L, 76R, fog lamps 78L, 78R, front turn indicators 80L, 80R, side turn indicators 82L, 82R, and welcome lamps 84L, 84R as lamps to be inspected. The welcome lamps 84L, 84R are lamps disposed near lower portions of the side mirrors, and can illuminate the nearby ground when a passenger unlocks, opens, or closes a vehicle door. The high-beam headlamp 72L, the low-beam headlamp 74L, and the front small lamp 76L are incorporated in a lamp unit 85L, and the high-beam headlamp 72L, the low-beam headlamp 74L, and the front small lamp 76L are incorporated in a lamp unit 85R.

Those lamps that are mounted on a rear portion of the vehicle 14 include brake lamps 86L, 86R, rear small lamps 88L, 88R, rear turn indicators 90L, 90R, back-up lamps 92L, 92R, a license plate lamp 94, and a high-mounted stop lamp 96 as lamps to be inspected. The high-mounted stop lamp 96 is a lamp disposed along the lower edge of a rear windshield 97. When the vehicle 14 is braked, the high-mounted stop lamp 96 is turned on as well as the brake lamps 86L, 86R.

In order for the vehicle lamp inspecting apparatus 10 to inspect these lamps for their turned-on state or blinking state, the cameras 22L, 22R, 24L, 24R share the lamps with each other for inspection. Specifically, the camera 22L is assigned to the high-beam headlamp 72L, the low-beam headlamp 74L, the front small lamp 76L, the fog lamp 78L, the front turn indicator 80L, and the welcome lamp 84L for inspection. The camera 22R is assigned to the high-beam headlamp 72R, the low-beam headlamp 74R, the front small lamp 76R, the fog lamp 78R, the front turn indicator 80R, and the welcome lamp 84R for inspection.

The camera 24L is assigned to the brake lamp 86L, the rear small lamp 88L, the rear turn indicator 90L, and the high-mounted stop lamp 96, and the camera 24R is assigned to the brake lamp 86R, the rear small lamp 88R, the rear turn indicator 90R, and the license plate lamp 94.

For sharing the lamps to be inspected, the cameras 22L, 22R, 24L, 24R are disposed in respective positions where they can appropriately capture images of the lamps to be inspected. The cameras 22L, 22R are disposed in left and right positions outside the track 12 (see FIG. 1) for capturing images of not only the lamp units 85L, 85R on the front side of the vehicle 14, but also the front turn indicators 80L, 80R and the welcome lamps 84L, 84R on the lateral sides of the vehicle 14. Therefore, no cameras dedicated to capture images of the lateral sides are required, and hence the number of image capturing units may be small. The cameras 24L, 24R are disposed behind the rear end of a vehicle 14a which is the longest among various vehicles 14 to be inspected, and can capture images of any rear portion of the vehicle 14 (see FIG. 1). Therefore, it is not necessary to add other image capturing units or to move the cameras 24L, 24R depending on the type of the vehicle 14.

Since the cameras 22L, 22R, 24L, 24R are disposed outside the track 12, the vehicle 14 can easily move into an inspection position. After the inspection of the vehicle 14 is finished, the vehicle 14 moves forward out of the inspection position, allowing a next vehicle 14 to move into the inspection position. Therefore, a so-called line inspection process can be performed.

If image capturing units are placed laterally of the vehicle 14, then since the image capturing units need to be somewhat spaced from the vehicle 14 to achieve a view of a suitable range, a wide space is required in addition to the track 12, or the image capturing units need to be equipped with a wide-angle lens. The wide-angle lens is not preferable because it is expensive and it induces large image distortions. In the vehicle lamp inspecting apparatus 10, though the cameras 22L, 22R, 24L, 24R are also somewhat spaced from the vehicle 14 to achieve a wide view, they are positioned near the track 12. Consequently, the vehicle lamp inspecting apparatus 10 is a space saver. The cameras 22L, 22R, 24L, 24R use a general-purpose lens and are inexpensive.

As shown in FIG. 6, the cameras 22L, 22R are disposed in a vertical position equal to or higher than the high-beam headlamps 72L, 72R and the low-beam headlamps 74L, 74R, and equal to or lower than the welcome lamps 84L, 84R. Since the high-beam headlamps 72L, 72R and the low-beam headlamps 74L, 74R have their optical axes directly slightly downward as they illuminate the road surface, they do not apply a large amount of light directly to the cameras 22L, 22R, so that no immoderate halation will occur. In addition, the cameras 22L, 22R can reliably capture images of the welcome lamps 84L, 84R since their light-emitting elements does not hide themselves behind the side mirrors.

The cameras 24L, 24R are disposed in a vertical position equal to or higher than the high-mounted stop lamp 96, can reliably capture an image of the high-mounted stop lamp 96 since it does not hide itself behind the rear trunk.

The cameras 22L, 22R, 24L, 24R are disposed outside of the track 12. Practically, the distance between the cameras 22L, 22R and the distance between the cameras 24L, 24R may be equal to or greater than the vehicle width. The vehicle width refers to the width of the body 36 exclusive of the side mirrors. If the distance between these cameras is equal to or greater than the width of the body 36, then the cameras can capture images of the lateral sides of the vehicle 14. With the cameras being of a height different from the side mirrors, the vehicle 14 can pass clear of the cameras. If the side mirrors incorporate lamps such as turn indicators, then the cameras may be disposed in positions spaced from each other by a distance equal to or greater than the width of the vehicle inclusive of the side mirrors.

The front cameras 22L, 22R and the wheel stops 38 may sufficiently be spaced from each other to allow the inspected vehicle 14 to move to the right or left out of the track 12, as indicated by the arrow A in FIG. 1.

The main processor 44 has a storage unit storing a plurality of inspection programs corresponding to model codes of vehicles 14. The inspection programs include data about a plurality of windows to be set on acquired image data. These windows are used for a plurality of purposes, e.g., for limiting an inspection area on acquired image data, for detecting positions of the front wheels 26L, 26R and the rear wheels 30L, 30R, and for confirming illumination by the spotlights 28L, 28R and the fluorescent lamps 32L, 32R.

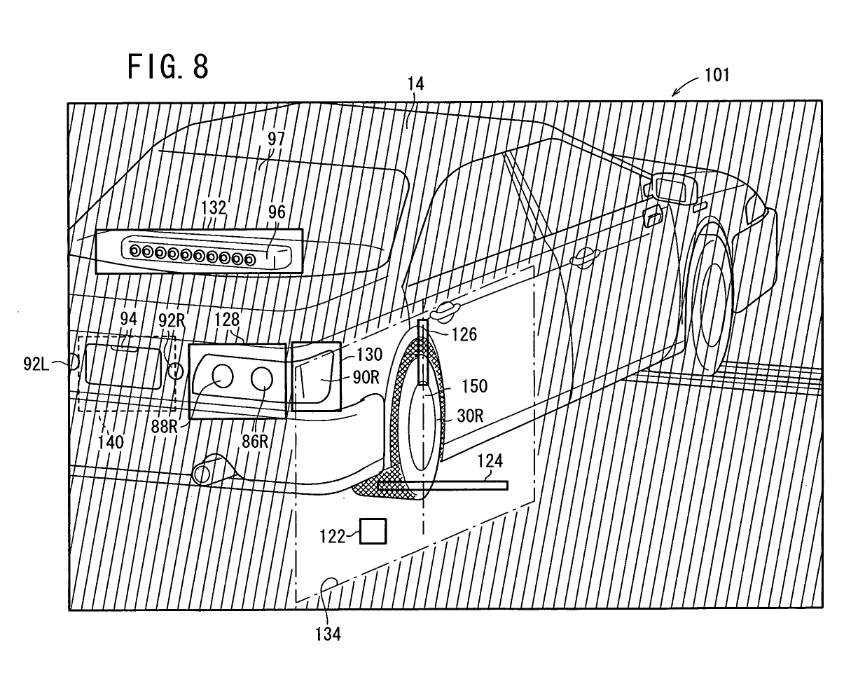

The windows will be described below with reference to the image data 100, 101 shown in FIGS. 7 and 8. The image data 100 is produced by the camera 22R when it captures an image of a right front portion of the vehicle 14, and the image data 101 is produced by the camera 24R when it captures an image of a right rear portion of the vehicle 14.

As shown in FIG. 7, on the image data 100, there are established a brightness confirmation window 102, a horizontal tire position confirmation window 104, a vertical body position confirmation window 106, a front lamp inspection window 108, a front turn indicator inspection window 110, a side turn indicator inspection window 112, a fog lamp inspection window 114, and a welcome lamp inspection window 116.

The brightness confirmation window 102 is a small window placed on the track 12 or wheel stops 38 within an illuminated range 103 that is illuminated by the spotlight 28R.

The horizontal tire position confirmation window 104 is a horizontally elongate window placed horizontally across a left edge Le and a right edge Re of a side wall (side surface) of the front wheel 26R within the illuminated range 103. The horizontal tire position confirmation window 104 is set at a position slightly higher than the track 12, but not on the body 36.

The vertical body position confirmation window 106 is a vertically elongate window placed in a reference position that is assumed to be vertically across a front wheel edge Te at the upper end of the front wheel 26R and a wheel house edge We at the upper end of the wheel house, within the illuminated range 103. The reference position is set as a position including an image to be inspected when the vehicle 14 is stopped centrally on the track 12.

The front lamp inspection window 108 is a window placed in a reference position that is assumed to include the high-beam headlamp 72R, the low-beam headlamp 74R, and the front small lamp 76R. The front lamp inspection window 108 contains the lamp unit 85R in its entirety therein. The front turn indicator inspection window 110, the fog lamp inspection window 114, and the welcome lamp inspection window 116 are windows placed in respective reference positions that are assumed to include the front turn indicator 80R, the fog lamp 78R, and the front turn indicator 80R, respectively, and have respective suitable areas greater than the images of the corresponding lamps.

As shown in FIG. 8, on the image data 101 which is produced by the camera 24R when it captures an image of the right rear portion of the vehicle 14, there are established a brightness confirmation window 122, a horizontal tire position confirmation window 124, a vertical body position confirmation window 126, a rear lamp inspection window 128, a rear turn indicator inspection window 130, and a high-mounted stop lamp inspection window 132.

The brightness confirmation window 122, the horizontal tire position confirmation window 124, and the vertical body position confirmation window 126 are windows corresponding respectively to the brightness confirmation window 102, the horizontal tire position confirmation window 104, and the vertical body position confirmation window 106, and are placed in an illuminated range 134 that is illuminated by the fluorescent lamp 32R. The rear lamp inspection window 128 is set in a reference position that is assumed to include the brake lamp 86R and the rear small lamp 88R. The rear turn indicator inspection window 130 and the high-mounted stop lamp inspection window 132 are set in respective reference positions that are assumed to include the rear turn indicator 90R and the high-mounted stop lamp 96, respectively.

The brightness confirmation window 102, the horizontal tire position confirmation window 104, brightness confirmation window 122, and the horizontal tire position confirmation window 124 are fixed in position. As to the other windows, default positions depending on the model code of the vehicle 14 are set as their reference positions. Therefore, the other windows are changed in their settings dependent on the horizontal position, etc. of the vehicle 14. The horizontal tire position confirmation window 124 may be changed in position depending on the wheelbase of the vehicle 14.

Although not shown, similar windows which are in horizontally symmetric relationship to the windows set on the image data 100, 101 are set on image data produced by the cameras 22L, 24L when they capture images of left front and rear portions of the vehicle 14. However, no high-mounted stop lamp inspection window 132 is established on the image data captured by the camera 24L. Instead, on the image data captured by the camera 24L, there is established a license plate lamp confirmation window 140 (see FIG. 8) in a reference position that is assumed to include the license plate lamp 94. In this manner, the objects to be inspected are equally assigned to the image data.

By thus appropriately establishing windows and processing image data in the windows, the amount of processing operation is made much smaller than if the entire image is to be processed, allowing the inspecting process to be performed more quickly.

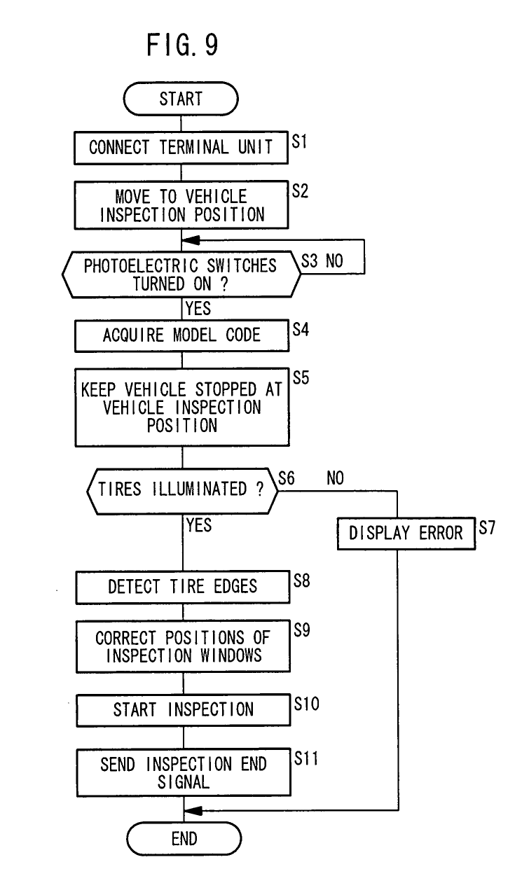

A method of inspecting the lamps of the vehicle 14 using the vehicle lamp inspecting apparatus 10 will be described below with reference to FIG. 9. In the description which follows, it is assumed that the processing sequence will be carried out in the order of indicated step numbers unless otherwise stated.

In step S1, a cover in the passenger compartment of the vehicle 14 is removed, and the terminal unit 20 is connected to a connector in the passenger compartment.

In step S2, the inspector drives the vehicle 14 to move it to a given inspection position. Specifically, as shown in FIG. 7, the inspector drives the vehicle 14 until the front wheels 26L, 26R ride between the two wheel stops 38, and then stops the vehicle 14, which is now positioned. At this time, the photoelectric switches 40L, 40R detect the arrival of the front wheels 26L, 26R at the inspection position, and transmit on-signals to the main processor 44.

In step S3, the main processor 44 waits until it is supplied with on-signals from the photoelectric switches 40L, 40R. If the main processor 44 detects the on-signals, then control goes to step S4.

In step S4, the main processor 44 acquires the production number code of the vehicle 14 and the terminal unit 20 that are recorded on the ID tag 34, through the RFID receiver 58, and turns off the pilot lamp 70 or changes the light color of the pilot lamp 70 that has been turned on.

In step S5, the main processor 44 communicates with the terminal unit 20 to confirm whether the vehicle speed is 0, the foot brake is turned off, and the side brake is turned on. The terminal unit 20 acquires the corresponding information from the ECU 18 and transmits the acquired information to the main processor 44. Since the vehicle speed is 0 and the side brake is turned on, it is confirmed that the vehicle 14 is completely stopped, so that a reliable lamp inspection can be conducted. Furthermore, since the foot brake is turned off, the brake lamps 86L, 86R and the high-mounted stop lamp 96 are de-energized, satisfying preparatory conditions for an inspection.

While confirming the above conditions, the main processor 44 simultaneously loads an inspection program corresponding to the acquired model code from the storage unit such as a hard disk or the like. The inspection program includes information for each of the types of vehicles 14. Specifically, the information includes an inspection sequence for the vehicle 14, information about lamps, and information about the above windows. The information about lamps represents the number, types, and positions of the lamps.

In step S6, the main processor 44 turns on the spotlights 28L, 28R and the fluorescent lamps 32L, 32R to illuminate the front wheels 26L, 26R and the rear wheels 30L, 30R. The main processor 44 confirms whether these lamps are properly energized or not. If the main processor 44 judges that these lamps are properly energized, then control goes to step S7. If the main processor 44 does not confirm that these lamps are properly energized, then the main processor 44 displays a predetermined error message in step S7.

The illumination is confirmed in step S6 as follows: The average brightness in the brightness confirmation window 102 on the image data 100 (see FIG. 7) is checked, and if the average brightness is equal to or higher than a predetermined value, then it is judged that the spotlight 28R is properly energized.

The energization of the fluorescent lamp 32R is confirmed based on the brightness confirmation window 122 (see FIG. 8). The energization of the left spotlight 28L and the fluorescent lamp 32L is similarly confirmed by checking the average brightness in the brightness confirmation windows on the image data acquired by the cameras 22L, 24L.

In step S8, edges of the front wheels 26L, 26R and the rear wheels 30L, 30R and edges of the wheel houses are detected. Specifically, the position of the vehicle 14 in the longitudinal direction thereof is determined by the wheel stops 38. Since the lateral position of the vehicle 14 can change within the width of the track 12, the lateral positions of the lamps also can change accordingly. Though the body 36 of the vehicle 14 is basically kept horizontal, it may slightly be tilted laterally due to a balance of the load on the vehicle 14, the vertical positions of the lamps can change if the body 36 is tilted. For appropriately inspecting the lamps, edges of the front wheels 26L, 26R and the rear wheels 30L, 30R and edges of the wheel houses are detected to detect the lateral position and tilt of the vehicle 14 for thereby accurately determining the positions of the lamps.

In step S9, the positions of the inspection windows are corrected based on the lateral position and tilt of the vehicle 14 which have been detected in step S8.

In step S10, the lamps are sequentially inspected based on the corrected windows.

In step S11, the main processor 44 sends a signal representing the end of the inspection and information representing the results of the inspection to the terminal unit 20, which displays the results of the inspection on the monitor 20a, and energizes the pilot lamp 70 or controls the pilot lamp 70 to display the original color.

The inspector checks the monitor 20a and recognizes the results of the inspection. If the results of the inspection are normal, then the inspector drives the vehicle 14 down the track 12 to a next inspection process. If the results of the inspection are abnormal, then the inspector drives the vehicle 14 into a retreat area for a necessary check.

Data of the results of the inspection obtained by the vehicle lamp inspecting apparatus 10 are stored in the respective storage units of the terminal unit 20 and the main computer 54 in association with the production number code of the vehicle 14. After the lamp inspection performed by the vehicle lamp inspecting apparatus 10 and all other inspections are finished, the terminal unit 20 and the ID tag 34 are removed from the vehicle 14.

Processing details of steps S8, S9, S10 shown in FIG. 9 will be described below.

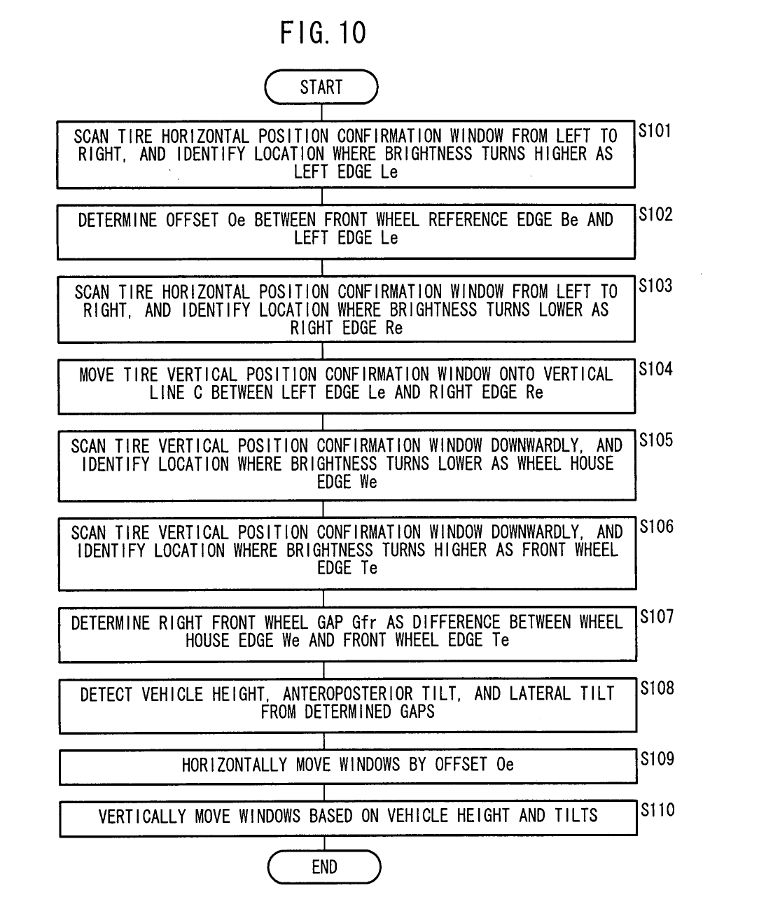

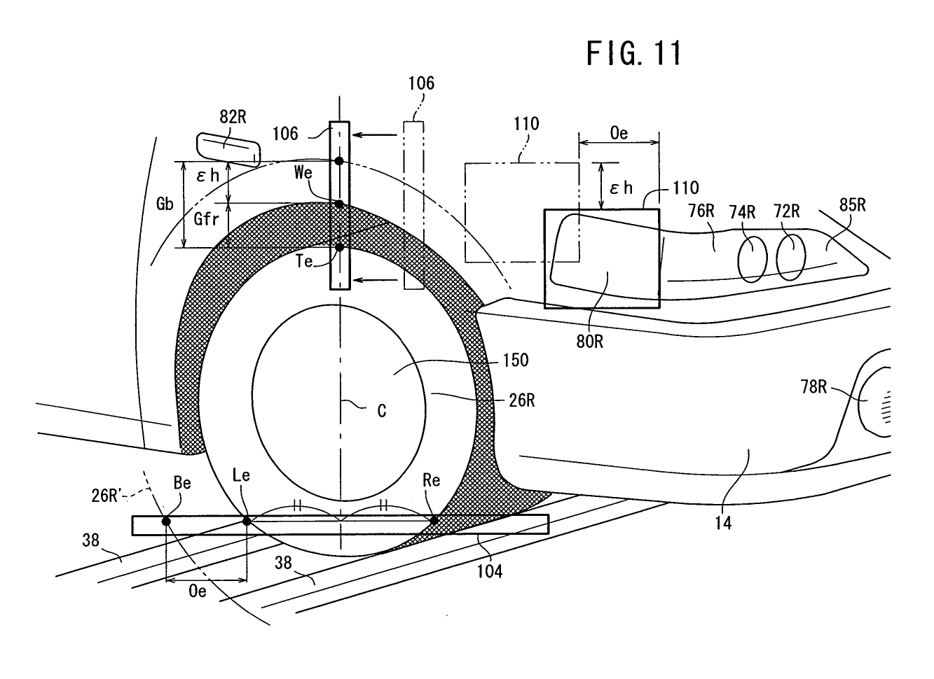

First, the processing details of steps S8, S9 will be described below with reference to FIGS. 10 and 11. The process shown in FIG. 10 is illustrated as a flowchart of a processing sequence. Of the processing sequence, steps S101 through S108 correspond to step S8, and steps S109, S110 to step S9.

In step S101 the horizontal tire position confirmation window 104 (see FIG. 11) is picked out, and scanned from left to right to successively determine brightness values of respective given pixel widths, e.g., respective pixels. At this time, a location where the brightness value changes so as to increase (to a brighter value) and the difference with the brightness value of the left adjacent area is in excess of a prescribed value, is identified as the left edge Le of the front wheel 26R. In view of the influence of noise or the like, an additional condition that after the brightness value has changed greatly, the brightness values of a plurality of successive areas on the right are in substantial agreement with each other may be satisfied, or a predetermined smoothing process may be performed (as is the case with a brightness change detecting process to be described later).

In step S102, an offset Oe representing the horizontal distance between a front wheel reference edge Be that serves as a reference for the default positions for the inspection windows shown in FIG. 11 and the left edge Le determined in step S101 is determined. The front wheel reference edge Be is defined as an upper right edge position in the image of a wheel 26R′ when the vehicle 14 is stopped at the center of the track 12.

In step S103, brightness values of respective given pixel widths are successively determined rightward from the left edge Le, and a location where the brightness value changes so as to decrease (to a darker value) and the difference with the brightness value of the left adjacent area is in excess of a prescribed value, is identified as the right edge Re of the front wheel 26R. In view of the image of a wheel 150, an additional condition that the horizontal distance from the left edge Le is equal to or greater than a predetermined value based on the diameter of the wheel 150, may be satisfied to detect the right edge Re.

In step S104, the vertical body position confirmation window 106 is corrected by being horizontally moved onto a vertical line C extending through an intermediate position between the left edge Le and the right edge Re (see FIG. 11), so that the vertical body position confirmation window 106 contains the front wheel edge Te at the upper end of the front wheel 26R and the wheel house edge We. The vertical position of the vertical body position confirmation window 106 is preset based on the tire diameter included in the model code. In this manner, the vertical body position confirmation window 106 is simply set based on the left edge Le and the right edge Re.

In step S105, the vertical body position confirmation window 106 is picked out and scanned downwardly to successively determine brightness values of respective given pixel widths. At this time, a location where the brightness value changes so as to decrease (to a darker value) and the difference with the brightness value of the upper adjacent area is in excess of a prescribed value, is identified as the wheel house edge We.

In step S106, brightness values of respective given pixel widths are successively determined downwardly from the wheel house edge We, and a location where the brightness value changes so as to increase (to a brighter value) and the difference with the brightness value of the upper adjacent area is in excess of a prescribed value, is identified as the front wheel edge Te of the front wheel 26R.

Since the camera 22R images the vehicle 14 obliquely, the gap between the front wheel edge Te and the wheel house edge We is the widest at the upper end. Therefore, the front wheel edge Te and the wheel house edge We can reliably be distinguished from each other and easily be detected. Furthermore, since the front wheel edge Te and the wheel house edge We lie substantially horizontally, they can easily and reliably be detected by the vertical scanning.

In step S107, a right front wheel gap Gfr representing the difference between the wheel house edge We and the front wheel edge Te is determined, and the difference εh between the right front wheel gap Gfr and a reference gap Gb is determined. Since the height of the front wheel 26R is known, the height of the wheel house edge We can accurately be determined by referring to the right front wheel gap Gfr based on the height of the front wheel 26R.

The processing of steps S101 through S107 is similarly performed on the other image data acquired by the cameras 22L, 24R, 24L to determine a left front wheel gap Gfl, a right rear wheel gap Grr, and a left rear wheel gap Grl (not shown).

In step S108, a vehicle height, an anteroposterior tilt, and a lateral tilt of the vehicle 14 are detected and inspected from the right front wheel gap Gfr, the left front wheel gap Gfl, the right rear wheel gap Grr, and the left rear wheel gap Grl. The values of the gaps, the vehicle height, the anteroposterior tilt, and the lateral tilt are compared with preset given values. If any of these values is judged as an abnormal value, then the main processor 44 displays a warning on the monitor 20a, and records the warning in the storage unit. For example, a lateral tilt Rf of the front portion of the vehicle 14 is determined as Rf←Gfr−Gfl, and an anteroposterior tilt Pr of the right portion of the vehicle 14 is determined as Pr←Gfr−Grr. If the absolute value of any of the lateral tilt Rf and the anteroposterior tilt Pr is greater than a prescribed threshold value, then it is judged as abnormal, and displayed and recorded.

In step S108, it is possible to inspect each of the suspensions supporting the body 36 for a prescribed height.

In step S109, the front lamp inspection window 108, the front turn indicator inspection window 110, the fog lamp inspection window 114, and the welcome lamp inspection window 116 in the right image data 100 (see FIG. 7) are positionally corrected by being horizontally moved by the offset Oe.

In step S110, the front lamp inspection window 108, the front turn indicator inspection window 110, the fog lamp inspection window 114, and the welcome lamp inspection window 116 are corrected in vertical position. These windows are positionally corrected by being vertically moved based on the vehicle height and the lateral tilt Rf that have been determined. If the vehicle height is greater than a reference value and the lateral tilt Rf is 0, then all the windows are uniformly moved upwardly by the same distance. If the vehicle height is equal to the reference value and the lateral tilt Rf is large, the front lamp inspection window 108 that is close to the vehicle center is moved a small distance, and the side turn indicator inspection window 112 that is remote from the vehicle center is moved a large distance.

Since the welcome lamp inspection window 116 is located rearward of the front wheel 26R, it is affected by the rear wheel 30R relatively greatly. Therefore, the welcome lamp inspection window 116 may more accurately be corrected in vertical position in view of the anteroposterior tilt Pr.

Through the above movement of the horizontal positions and the vertical positions, the front lamp inspection window 108, for example, is moved to a position where it reliably contains the high-beam headlamp 72R, the low-beam headlamp 74R, and the front small lamp 76R.

Though not described in detail, the windows in the left front image, the left rear image, and the right rear image are also moved horizontally and vertically by the same process as described above.

As described above, the horizontal positions of the respective four wheels, i.e., the front wheels 26L, 26R and the rear wheels 30L, 30R, are detected, and the wheel edges We thereof are detected and their heights are determined. Accordingly, the vehicle height and the tilts of the vehicle body are accurately determined to detect the position and posture of the vehicle 14 three-dimensionally. The lamp units 85L, 85R and the other lamps are thus positionally identified accurately. Therefore, the corresponding inspection windows can appropriately be established.

Inasmuch as the camera 22R images the vehicle 14 obliquely from a front side position, the side surface of the front wheel 26R, the lamp unit 85R, the side turn indicator 82R, and the welcome lamp 84R are contained in one image capturing range. The image of the front wheel 26R is used to detect the position of the vehicle 14, and the images of the lamp unit 85R, the side turn indicator 82R, and the welcome lamp 84R are used to inspect their turned-on state and blinking state. The camera 22R can thus be used to both detect the position of the vehicle and inspect the lamps.

Of the horizontal and vertical corrective movement in steps S109, S110, the movement of the front turn indicator inspection window 110 as a typical example is shown in FIG. 11. Since the front turn indicator inspection window 110 is close to the right wheel house, a vertical distance by which it is moved may approximately be represented by the difference εh referred to above.

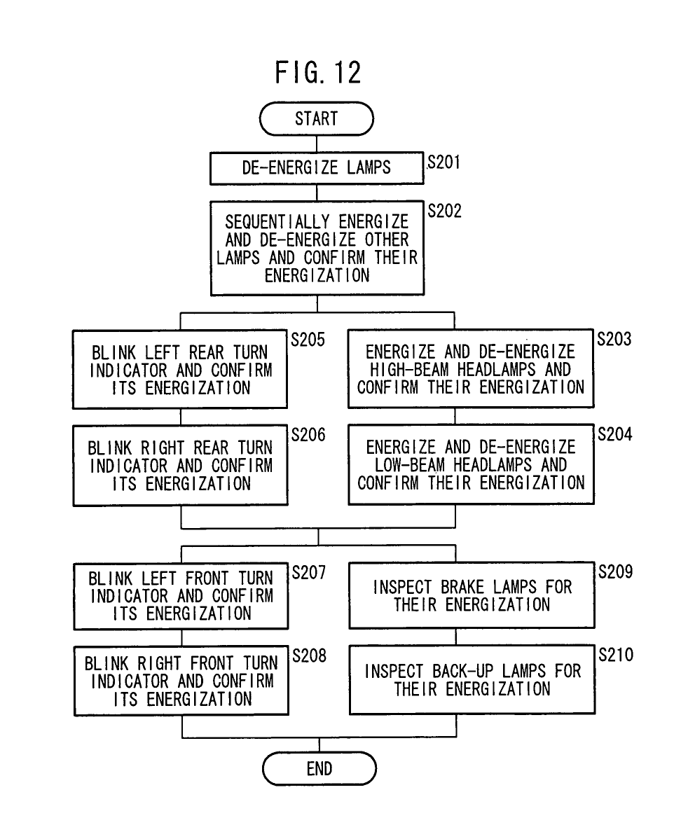

The processing details of step S10 (see FIG. 9) will be described below with reference to FIG. 12. According to the processing of step S10, when the arrival of the vehicle 14 at the inspection position is detected based on the signals from the photoelectric switches 40L 40R, the main processor 44 controls the terminal unit 20 and the ECU 18 to energize or blink the lamps, acquires image data from the cameras 22R, 22L, 24R, 24L, and inspects the lamps based on the image data.

In step S201, the main processor 44 sends a predetermined signal to the terminal unit 20 to control the ECU 18 to turn off all the lamps that can be controlled, and turn off the spotlights 28L, 28R and the fluorescent lamps 32L, 32R.

In step S202, the main processor 44 sequentially energizes and de-energizes the front small lamps 76L, 76R, the fog lamps 78L, 78R, the welcome lamps 84L, 84R, the rear small lamps 88L, 88R, and the license plate lamp 94, and confirms their energization based on the images obtained from the cameras 22L, 22R, 24L, 24R.

Since the lamps are not energized simultaneously, if there is a wrong connection for an unexpected reason, then the lamps are energized in a sequence which is different from a prescribed sequence. Therefore, it is possible to detect the presence of such a wrong connection.

According to the inspection in step S202, a low-brightness lamp can be inspected without being affected by a high-brightness lamp.

Then, the main processor 44 simultaneously inspects the headlamps for energization in steps S203, S204 and inspects the rear turn indicators for blinking in steps S205, S206. Actually, the main processor 44 can simultaneously inspect the headlamps for energization and inspect the rear turn indicators for blinking in one routine without the need for multitask processing. However, for an easier understanding of the invention, FIG. 12 shows separate branched processing sequences for the two inspecting processes.

In step S203, the main processor 44 sends a predetermined signal to the terminal unit 20 to control the ECU 18 to energize and de-energize the high-beam headlamps 72L, 72R, and confirms their energization based on the images obtained from the cameras 22L, 22R.

In step S204, the main processor 44 sends a predetermined signal to the terminal unit 20 to control the ECU 18 to energize and de-energize the low-beam headlamps 74L, 74R, and confirms their energization based on the images obtained from the cameras 22L, 22R.

In step S205, the main processor 44 sends a predetermined operation signal to the terminal unit 20 to control the ECU 18 to blink the rear turn indicator 90L. The main processor 44 confirms proper blinking of the rear turn indicator 90L and its blinking period based on the left rear image data obtained from the camera 24L.

In step S206, the main processor 44 inspects the rear turn indicator 90R for blinking in the same manner as it inspects the rear turn indicator 90L in step S205. The rear turn indicator 90L and the rear turn indicator 90R are inspected separately, so that a wrong connection (an inverse connection) can be detected.

Steps S205, S206 are executed simultaneously with steps S203, S204. The rear turn indicators 90L, 90R are sufficiently spaced from the headlamps, have their optical axes opposite from those of the headlamps, and are inspected based on the different image data 100, 101. Therefore, the rear turn indicators 90L, 90R are properly inspected without being affected by the high-brightness head lamps. Actually, the rear turn indicator 90L blinks in synchronism with the front turn indicator 80L and the side turn indicator 82L, and the rear turn indicator 90R blinks in synchronism with the front turn indicator 80R and the side turn indicator 82R. Since the front turn indicators 80L, 80R and the side turn indicators 82L, 82R are of relatively low brightness, they do not adversely affect the inspection of the high-beam headlamps 72L, 72R and the low-beam headlamps 74L, 74R.

After it has been confirmed that the processing of steps S204, S206 is finished, steps S207, S209 are simultaneously executed.

In step S207, the main processor 44 sends a predetermined operation signal to the terminal unit 20 to control the ECU 18 to blink the front turn indicator 80L. The main processor 44 inspects the front turn indicator 80L according to the same sequence as with step S203.

In step S208, the main processor 44 sends a predetermined operation signal to the terminal unit 20 to control the ECU 18 to blink the front turn indicator 80R. The main processor 44 inspects the front turn indicator 80R according to the same sequence as with step S203.

In step S209, the brake lamps 86L, 86R and the high-mounted stop lamp 96 are inspected for their energization. The brake lamps 86L, 86R and the high-mounted stop lamp 96 are directly connected to a switch linked to the brake pedal and are not controlled by the ECU 18. Therefore, these lamps are energized by the inspector depressing the brake pedal and inspected.

Specifically, the main processor 44 sends a signal representing a start to inspect the brake lamps to the terminal unit 20. Having received the signal, the terminal unit 20 displays a message “DEPRESS FOOT BRAKE” on the monitor 20a. The operator who reads the message depresses the brake lamp and energizes the brake lamps 86L, 86R and the high-mounted stop lamp 96. The main processor 44 inspects the brake lamps 86L, 86R and the high-mounted stop lamp 96 for their energization based on the display in the rear lamp inspection window 128 and the high-mounted stop lamp inspection window 132 in the images obtained from the cameras 24L, 24R.

After the inspection, the main processor 44 sends information indicative of the end of the brake lamp inspection and the results of the inspection to the terminal unit 20, and displays a message “BRAKE LAMP INSPECTION IS FINISHED. BRAKE LAMPS ARE NORMAL.”, for example, on the monitor 20a.

In step S210, the main processor 44 inspects the back-up lamps 92L, 92R for their energization. The back-up lamps 92L, 92R are directly connected to a switch linked to the shift lever and are not controlled by the ECU 18. Therefore, these lamps are energized by the inspector making a shift change and inspected. The main processor 44 displays a suitable message on the monitor 20a in the same manner as with step S209, prompting the operator to make a shift change for inspecting the back-up lamps 92L, 92R.

Operation instructions given to the inspector in steps S209, S210 are not limited to the message format, but may be given as a graphic format such as pictographic characters or a change in the sound pattern of a built-in buzzer.

As described above, according to the lamp inspection, the energization of the headlamps, the blinking of the turn indicators, and the energization of other lamps are inspected based on different image data (data having different image capturing times or data captured by different cameras and having different image capturing ranges). Accordingly, the highly bright light emitted from the headlamps do not adversely affect the image data used to inspect the turn indicators and the other lamps, and hence these other lamps can be inspected accurately. Furthermore, the different lamps can be simultaneously inspected based on the image data with the different image capturing ranges, so that the inspection time can be shortened.

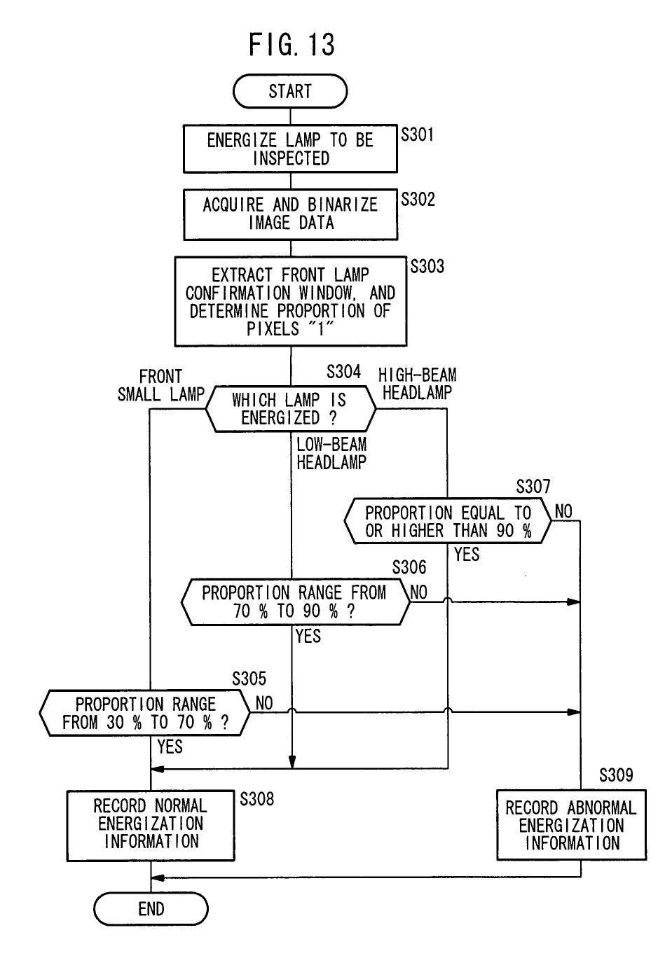

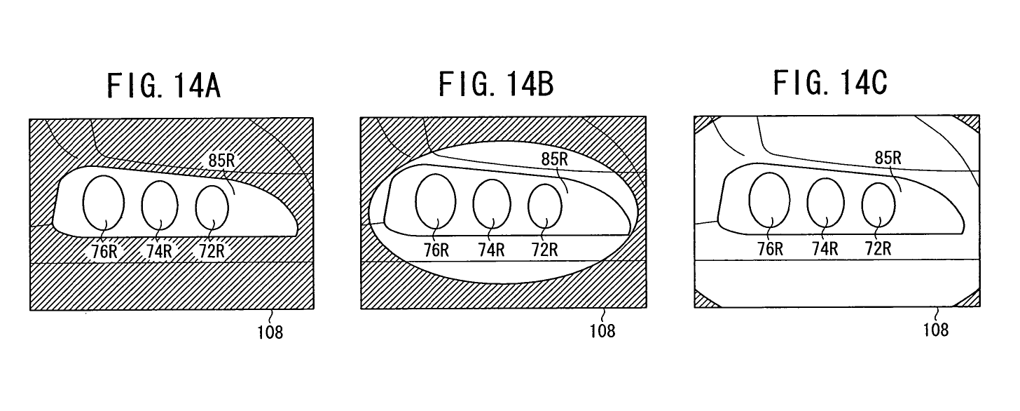

A specific lamp inspecting process for inspecting, for example, the high-beam headlamp 72R, the low-beam headlamp 74R, and the front small lamp 76R, will be described below with reference to FIGS. 13 through 14C. When either one of the lamps of the lamp unit 85R is turned on, the emitted light is somewhat diffused by the front lens, and the lens as a whole is visually recognized as being bright. However, which one of the lamps is turned on can be distinguished and inspected by the following process: The area of the front lamp inspection window 108 used for this inspection is set to about three times the apparent area of the lamp unit 85R.

In step S301, the main processor 44 sends an operation signal for turning on either one of the high-beam headlamp 72R, the low-beam headlamp 74R, and the front small lamp 76R to the terminal unit 20, enabling the terminal unit 20 and the ECU 18 to turn on the lamp.

In step S302, the main processor 44 acquires image data from the camera 22R, and binarizes the acquired image data. Specifically, the acquired original image data are data having a plurality of gradations (e.g., 256 gradations) at each pixel. The original image data are converted into binary image data by setting a pixel whose gradation is equal to greater than a preset gradation value to “1” and setting a pixel whose gradation is smaller than the preset gradation to “0”. The binary image data thus obtained in advance can subsequently be processed easily for quick inspection.

In step S303, the front lamp inspection window 108 on the image data is picked out, and the proportion Rate of pixels “1” to all the pixels is determined. For example, if there are 200 pixels “1” in all 400 pixels, then the proportion Rate is Rate=50% (= 200/400×100).

Thereafter, in step S304, branching occurs depending on the type of the energized lamp. If the front small lamp 76R is turned on (step S202), then control goes to step S305. If the low-beam headlamp 74R is turned on (step S204), then control goes to step S306. If the high-beam headlamp 72R is turned on, then control goes to step S307.

In step S305, if the proportion Rate is in the range from 30% to 70%, then it is judged that the front small lamp 76R is energized normally, and control goes to step S308. If the proportion Rate falls out of the range, then it is judged that the front small lamp 76R is de-energized or another lamp is energized, and control goes to step S309. In this case, a wire disconnection, a bulb burnout, or a wrong connection is recognized as being present.

If the front small lamp 76R is energized, since the brightness thereof is low, as shown in FIG. 14A, the pixels “1” (not hatched) are essentially limited to the area representative of the lamp unit 85R. The acceptable range for those pixels is from 30% to 70%.

In step S306, if the proportion Rate is in the range from 70% to 90%, then it is judged that the low-beam headlamp 74R is energized normally, and control goes to step S308. If the proportion Rate falls out of the range, then it is judged that the low-beam headlamp 74R is de-energized or another lamp is energized, and control goes to step S309.

If the low-beam headlamp 74R is energized, since the brightness thereof is high, but the optical axis thereof is considerably low, as shown in FIG. 14B, a halation occurs in the vicinity of the light source and the pixels therein are “1”. The acceptable range for those pixels is from 70% to 90%.

In step S307, if the proportion Rate is 90% or higher, then it is judged that the high-beam headlamp 72R is energized normally, and control goes to step S308. If the proportion Rate is lower than 90%, then it is judged that the high-beam headlamp 72R is de-energized or another lamp is energized, and control goes to step S309.

If the high-beam headlamp 72R is energized, since the brightness thereof is high and the optical axis thereof is relatively high, as shown in FIG. 14C, a halation occurs almost entirely in the front lamp inspection window 108. The acceptable range for those pixels is 90% or greater.

In step S308, information indicating that the corresponding lamp is energized normally is stored in the given storage unit. In step S309, information indicating that the corresponding lamp malfunctions is stored in the given storage unit.

After step S308 or S309, the main processor 44 sends a signal for de-energizing the corresponding lamp to the terminal unit 20.

As described above, the front small lamp 76R, the low-beam headlamp 74R, and the high-beam headlamp 72R are incorporated in the lamp unit 85R and positioned very closely to each other. Since the front lens somewhat diffuses the emitted light, it is difficult to determine which one of the lamps is energized. Depending on the model of the lamp units 85L, 85R, the reflecting plate disposed behind the light sources commonly reflects the light emitted from the lamps, making it more difficult to determine which one of the lamps is energized.

According to the processing sequence shown in FIG. 13, the proportion Rate representative of the ratio of the area where the brightness value is equal to or higher than a threshold value is used to detect different average brightness levels in the front lamp inspection window 108 for thereby determining which one of the front small lamp 76R, the low-beam headlamp 74R, and the high-beam headlamp 72R is energized and inspecting the energized lamp. Accordingly, the front small lamp 76R, the low-beam headlamp 74R, and the high-beam headlamp 72R in the lamp unit 85R can be inspected in the single front lamp inspection window 108 without the need for identifying the positions of these three lamps.

According to another process of detecting different brightness levels, they may be determined based on a highest brightness level in the front lamp inspection window 108, for example. However, because the highest brightness level often tends to exceed the measurement range and to be saturated, it is difficult to accurately calculate the highest brightness level from the actual image data. On the other hand, the vehicle lamp inspecting apparatus 10 detects different average brightness levels in the front lamp inspection window 108 according to the proportion Rate based on the area from the binarized image data, so that the front small lamp 76R, the low-beam headlamp 74R, and the high-beam headlamp 72R can accurately be identified.

Dependent on the actual usage, when the high-beam headlamp 72R is turned on, the front small lamp 76R may also be turned on simultaneously, and similarly when the low-beam headlamp 74R is turned on, the front small lamp 76R may also be turned on simultaneously. In this case, the acceptable ranges in steps S306, S307 may be adjusted in view of the energization of the front small lamp 76R.

The processing sequence shown in FIG. 13 represents the inspection of the right lamp unit 85R. However, the left lamp unit 85L can similarly be inspected. The other lamps can be inspected in the same manner as with the front small lamp 76R. The fog lamp 78R, the welcome lamp 84R, the rear small lamp 88R, and the license plate lamp 94 can be inspected using the fog lamp inspection window 114, the welcome lamp inspection window 116, and the license plate lamp confirmation window 140, respectively.

The welcome lamps 84R, 84L may be inspected by establishing a window similar to the brightness confirmation window 122 on a ground surface as an illuminated surface of the track 12, and detecting the illuminance of the window. The license plate lamp 94 may also be inspected similarly by establishing an inspection window on the license plate as an illuminated surface. In this case, welcome lamps 84R, 84L and the license plate lamp 94 may not have their light-emitting elements included in the image data.

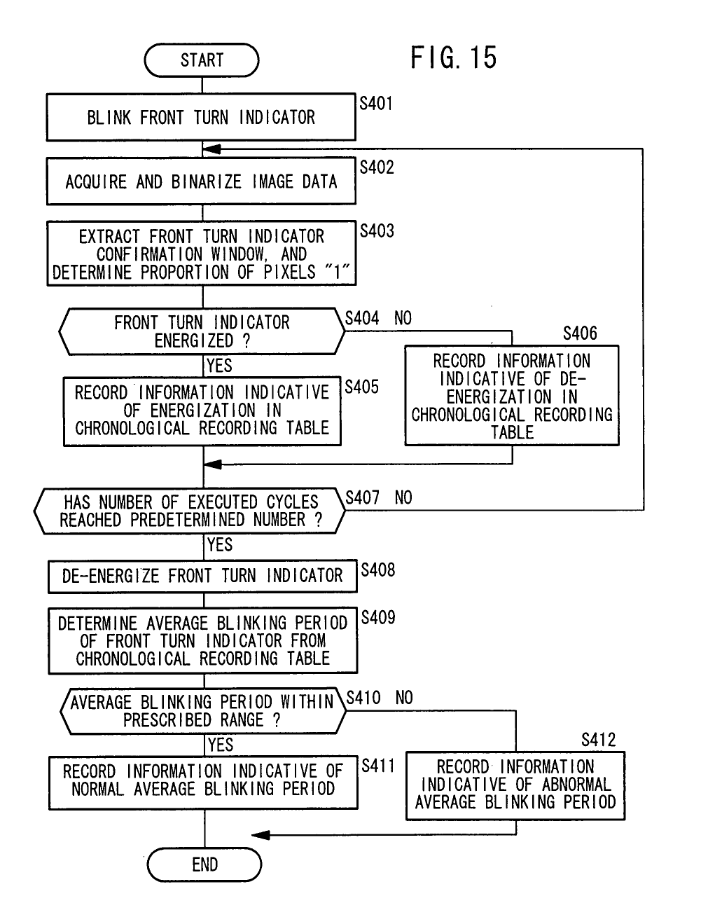

A process of inspecting the turn indicators will be described below with reference to FIG. 15. The turn indicators, i.e., the front turn indicators 80L, 80R, the side turn indicators 82L, 82R, and the rear turn indicators 90L, 90R are blinked at a predetermined cyclic period based on a blinking timer function of the ECU 18 or the other processor. Whether the cyclic period is appropriate or not is inspected according to a procedure shown in FIG. 15.

In step S401, the main processor 44 sends an operation signal for blinking the front turn indicator 80R to the terminal unit 20, and resets a given execution cycle counter to 0.

In step S402, the main processor 44 acquires image data from the camera 22R and binarizes the acquired image data in the same manner as with step S302.

In step S403, in the same manner as in step S303, the front turn indicator inspection window 110 is picked out, and the proportion Rate of pixels “1” whose brightness values are equal to or higher than a predetermined threshold value is determined.

In step S404, it is confirmed whether the front turn indicator 80R is energized or not. If the front turn indicator 80R is energized, then control goes to step S405. If the front turn indicator 80R is de-energized, then control goes to step S406. Specifically, if the proportion Rate is 30% or higher, then the front turn indicator 80R may be judged as energized, and if the proportion Rate is less than 40%, then the front turn indicator 80R may be judged as de-energized. The binarizing process may be omitted, and the energization of the front turn indicator may be judged based on the average brightness in the front turn indicator inspection window 110.

In step S405, information indicative of the energization is recorded in a recording area next to the preceding recording area of a predetermined chronological recording table provided in the storage unit. In step S405, information indicative of the de-energization is recorded therein. Thereafter, control goes to step S406.

In step S406, the execution cycle counter is incremented, and then it is confirmed whether the execution cycle counter has reached a predetermined count or not. If the number of cycles in which the loop indicated by steps S402 through S405 is executed has reached the predetermined count, then control goes to step S407. If the number of cycles has not reached the predetermined count, then control goes back to step S402 to continue the processing sequence. The number of cycles is set to a value corresponding to a time in which the front turn indicator 80R blinks three times or more. It is assumed that the loop indicated by steps S402 through S405 is controlled so as to be executed in each prescribed minute time based on a suitable timer function.

In step S407, the main processor 44 sends an operation signal for finishing the blinking of the front turn indicator 80R to the terminal unit 20, thereby de-energizing the front turn indicator 80R.

In step S408, an average blinking period of the front turn indicator 80R is determined from the information recorded in the chronological recording table. Specifically, the chronological recording table has three or more alternate areas where information indicative of the energization is successively recorded and information indicative of the de-energization is successively recorded. The time of three cyclic periods is determined from the intervals between locations where these areas change, and the determined time is divided by 3.

In step S409, it is confirmed whether the determined average blinking period falls in a prescribed range or not. If the determined average blinking period falls in the prescribed range, then control goes to step S410. If the determined average blinking period falls out of the prescribed range, then control goes to step S411.

In step S410, information indicating that the average blinking period of the front turn indicator 80R is normal is recorded in the storage unit. In step S411, information indicating that the average blinking period of the front turn indicator 80R is abnormal is recorded in the storage unit.

Thereafter, the inspection process to confirm the blinking of the turn indicator as shown in FIG. 15 is put to an end. In the procedure shown in FIG. 15, the front turn indicator 80R is inspected by way of example. The front turn indicator 80L, the side turn indicators 82L, 82R, and the rear turn indicators 90L, 90R are also inspected according to a similar procedure. Of these turn indicators, the side turn indicator 82R and the rear turn indicator 90R are inspected using the side turn indicator inspection window 112 and the rear turn indicator inspection window 130, respectively. The front turn indicator 80R and the side turn indicator inspection window 112 may be inspected simultaneously as they are imaged in the same image data 100 (see FIG. 7).

With the vehicle lamp inspecting apparatus 10 according to the present embodiment, as described above, when the vehicle position recognizing unit 16 detects the arrival of the vehicle 14 at the inspection position, the lamps are automatically turned on or blinked by the terminal unit 20 and the ECU 18, and the lamps are imaged by the cameras 22L, 22R, 24L, 24R. Because the inspection of the lamps is thus automated, human-induced inspection errors are prevented from occurring, and the inspection is carried out quickly.

The terminal unit 20 is loaded with inspection sequences depending on vehicles 14, and operates in cooperation with the main processor 44 for easily automating inspection. Since the terminal unit 20 is capable of wireless communications and can be used for other inspection purposes, the terminal unit 20 does not need to be detached in each inspecting process. As the vehicle lamp inspecting apparatus 10 has the vehicle position recognizing unit 16, the vehicle lamp inspecting apparatus 10 is suitably applicable to the inspection line where the inspector drives the assembled vehicle 14 to move on the track 12.

With the vehicle lamp inspecting method according to the present embodiment, the horizontal tire position confirmation window 104 set at a position across the front wheel 26R is scanned to detect the edges Le, Re for appropriately detecting the positional relationship between the lamps of the vehicle 14 and the camera 22R. Therefore, the offset Oe representing the difference between the edge Le and the front wheel reference edge Be can be determined to correct the inspection windows by moving them to positions including the lamps. The vehicle lamp inspecting method does not employ complex vehicle positioning mechanisms, etc., but can employ simple, inexpensive devices.

The inspection windows are established in positions including the lamps based on the model code acquired from the ID tag 34 and the detected offset Oe. Consequently, the image data 100 makes itself compatible with different models of vehicles 14 for increased versatility. Therefore, the vehicle lamp inspecting method is suitably applicable to the inspection line where the inspector drives the assembled vehicle 14 to move on the track 12.

With the vehicle lamp inspecting method according to the present embodiment, the image data 100 acquired when the high-beam headlamp 72R, the low-beam headlamp 74R, and the front small lamp 76R of the lamp unit 85R are imaged while they are independently being energized, are binarized based on a threshold value representing a predetermined brightness value. Thereafter, the area ratio Rate between the area of pixels “1” in the front lamp inspection window 108 and the entire area of the front lamp inspection window 108 is determined and compared with a predetermined acceptable range. Therefore, the operating states of the lamps can simply be inspected. The vehicle lamp inspecting apparatus 10 requires no projection screen and is simple and small. Furthermore, complex procedures such as a camera aperture control process, etc. are not necessary.

With the vehicle lamp inspecting method according to the present embodiment, the horizontal tire position confirmation window 104 is scanned to detect the edge Le of the front wheel 26R for identifying the horizontal position of the vehicle 14. Based on the edge Le, etc., the vertical body position confirmation window 106 is established in a position vertically crossing the wheel edge We, and is scanned to accurately determine the height of the body 36 at the position.

As the cameras 22R, 22L, 24R, 24L capture images from oblique positions in fields of view containing the front or rear surface and the side surface of the vehicle 14, the cameras 22R, 22L, 24R, 24L are used to both detect the position of the vehicle and inspect the lamps. Therefore, the vehicle lamp inspecting apparatus 10 is inexpensive to construct, and is widely applicable to vehicles 14 having different overall lengths. The vehicle lamp inspecting apparatus 10 is thus applicable to the inspection line where the inspector drives the assembled vehicle 14 to move on the track 12.

The brightness referred to above is not limited to luminance [cd/m²] in a narrower sense, but is used to include a quantity such as the magnitude of entire lightness in a given window in a broader sense, for example.

1. A vehicle lamp inspecting apparatus comprising:
a vehicle position recognizing unit for detecting arrival of a vehicle at a prescribed inspection position;
a terminal unit connected to an electronic control unit mounted on said vehicle, for sending an operation signal to the electronic control unit to turn on or blink lamps;
image capturing devices for capturing images of the lamps on the vehicle that has reached said inspection position; and
an inspection unit connected to said vehicle position recognizing unit and said terminal unit, for acquiring image data from said image capturing devices;
wherein when said inspection unit detects the arrival of said vehicle at said inspection position based on a signal from said vehicle position recognizing unit, said inspection unit controls said terminal unit and said electronic control unit to turn on or blink said lamps, acquires the image data from said image capturing devices, and inspects said lamps based on said image data.

2. A vehicle lamp inspecting apparatus according to claim 1, wherein said lamp includes headlamps, turn indicators, and other lamps; and
said inspection unit inspects said headlamps for energization, said turn indicators for blinking, and said other lamps for energization based on different image data.

3. A vehicle lamp inspecting apparatus according to claim 1, wherein said image capturing devices are disposed in lateral positions outside the width of the vehicle in front of a front end of said vehicle which has reached said inspection position and in lateral positions outside the width of the vehicle behind a rear end of said vehicle which has reached said inspection position, respectively.

4. A method of inspecting lamps of a vehicle with image capturing devices and an inspection unit connected to a terminal unit having a communication function, comprising connecting said terminal unit to an electronic control unit mounted on said vehicle, sending an operation signal from said inspection unit through the terminal unit to said electronic control unit to turn on or blink the lamps of said vehicle when said inspection unit detects the arrival of said vehicle at a prescribed inspection position, acquiring image data by capturing images of said lamps with said image capturing devices, and processing said image data to inspect said lamps.

5. A method according to claim 4, wherein when said image capturing devices capture the images of the lamps, said image capturing devices capture the images so that said image data contain the lamps and side surfaces of wheels of said vehicle, said method comprising the steps of:
establishing, on said image data, elongate wheel position confirmation windows in positions horizontally across edges (Le, Re) of the side surfaces of said wheels, and inspection windows in reference positions;
longitudinally scanning said wheel position confirmation windows to detect the edges (Le, Re) of the side surfaces of said wheels from a brightness change;
determining an offset (Oe) representing the difference between said edges (Le, Re) and a wheel reference position;
correcting said inspection windows by moving the inspection windows to positions including said lamps, based on said offset (Oe); and
inspecting operating states of said lamps by determining brightness in the corrected inspection windows.

6. A method according to claim 5, wherein when said image capturing devices capture the images of the lamps, said wheels are illuminated by illuminating units.

7. A method according to claim 4, wherein when image capturing devices capture the images of the lamps, said image capturing devices capture the images so that said image data contain the lamps of said vehicle, said method comprising the steps of:
acquiring a model of said vehicle;
detecting a stopped position of said vehicle from said model and said image data;
establishing, on said image data, inspection windows in positions including said lamps based on said model and the detected stopped position; and
inspecting operating states of said lamps by determining brightness in said inspection windows.

8. A method according to claim 4, wherein said lamps include a plurality of lamps incorporated in a lamp unit, and when said image capturing devices capture the images of the lamps, said image capturing devices capture the images so that said image data contain said lamp unit while at least one of said lamps is being energized, said method comprising the steps of:
establishing an inspection window including an image of said lamp unit on said image data;
binarizing said inspection window on said image data with a predetermined brightness value;
determining an area of a portion of said inspection window which represents one of two binarized values; and
inspecting operating states of said lamps based on said area.

9. A method according to claim 8, wherein acceptable ranges for said area are established depending on the types of said lamps, and operating states of said lamps of the respective types are inspected based on said acceptable ranges.

10. A method according to claim 4, comprising:
a first step of, when image capturing devices capture the images of the lamps, capturing the images obliquely so that said image data contain the lamps and side surfaces of wheels of said vehicle;
a second step of establishing, on said image data, elongate wheel position confirmation windows in positions horizontally across edges (Le, Re) of the side surfaces of said wheels;
a third step of longitudinally scanning said wheel position confirmation windows to detect the edges (Le, Re) of the side surfaces of said wheels from a brightness change;
a fourth step of establishing elongate body position confirmation windows in positions vertically across an edge (We) of a body of the vehicle, based on the edges (Le, Re) of the side surfaces of said wheels;
a fifth step of longitudinally scanning said body position confirmation windows to detect the edge (We) of said body from a brightness change;
a sixth step of detecting a vehicle height and a tilt of said body from said edge (We) of said body; and
a seventh step of detecting positions of said lamps and inspecting operating states of said lamps based on said vehicle height and said tilt.

11. A method according to claim 10, wherein said seventh step comprises:
a sub-step of establishing inspection windows in reference positions; and
a sub-step of correcting said inspection windows by moving the inspection windows to positions including said lamps, based on said vehicle height or said tilt,
wherein the operated states of said lamps are inspected by determining brightness in the corrected inspection windows.

12. A method according to claim 10, wherein the wheel position confirmation windows are established in positions horizontally across the edges (Le, Re) of side surfaces of tires of said wheels in said second step;
said wheel position confirmation windows are longitudinally scanned to detect said edges (Le, Re) of the side surfaces from a brightness change in said third step; and
said body position confirmation windows are established in positions based on the diameters of said tires which have been recorded in advance, on a vertical line passing through a central position between the detected edges (Le, Re) of the side surfaces in said fourth step.
